(19) United States
(12) Patent Application Publication
(10) Pub. No.: US 2005/0076064 A1
(43) Pub. Date: Apr. 7, 2005

(54) MR APPLICATION SAVE AND RESTORE SYSTEM

(75) Inventors: Deepa Thomas, Waukesha, WI (US); Kristine Gould, Delafield, WI (US); Robert Haworth, Brookfield, WI (US)

Correspondence Address: ARTZ & ARTZ, P.C., 28333 TELEGRAPH RD., SUITE 250, SOUTHFIELD, MI, 48034, US

(73) Assignee: GE MEDICAL SYSTEMS GLOBAL TECHNOLOGY COMPANY, LLC, Waukesha, WI (US)

(21) Appl. No.: 10/605,470

(22) Filed: Oct. 1, 2003

(51) Int. Cl. G06F 7/00

(52) U.S. Cl. 707/200

(57) ABSTRACT

A method of saving and restoring an application for an imaging system (10) includes loading a developing environment (92). An initial application, for the imaging system (10), is loaded or generated in the developing environment (92). The initial application is modified to generate an updated application. Component and link modifications between the initial application and the updated application are saved. The updated application is then stored with the modifications in a tag file. The tag file is selected and the updated application is restored according to the tag file.

### BACKGROUND OF INVENTION

The present invention relates generally to magnetic resonance imaging systems and tools. More particularly, the present invention relates to a system and method of storing and restoring magnetic resonance applications.

Several tools exist for the development of magnetic resonance (MR) imaging applications to be applied on an MR imaging system. The tools build a particular application environment through utilization and access to various system software components. Each component has associated tasks corresponding to MR categories, such as pulse sequencing, visualization, data processing, and image reconstruction.

It is desirable to build new MR applications within a short period of time. In order to achieve rapid application development, visual tools based on JAVA™, exist to create various application developing environments. Components can be assembled or contained in new combinations using simple known drag-and-drop window techniques. Node connections are created between components with associated linking information and each component may be reconfigured with new parameter sets or property settings. As desired, the above-stated component and node connection features are performed without the need for the writing or compiling of new source code.

In order to reuse and execute a previously created application on an MR scanner, the application must have originally been saved and must be restored. Commercial off the shelf mechanisms and formats for saving and restoring the applications do exist but unfortunately are inadequate and performance limited.

Current commercial saving and restoring mechanisms are only somewhat compatible with the existing MR imaging system software. Current commercial saving and restoring mechanisms in operation involve the traversing of a tree of components. The state of each component is either saved in a binary format, referred to as serialization, or the properties that have current values that differ from their default values are saved in an extensible markup language (XML) format, which is referred to as archiving.

Serialization requires determining the version of the MR imaging software classes. During serialization, versions of the components are stored such that when new versions are created, files that were saved using a previous version cannot be restored due to incompatibility reasons. For example, when a restore is performed on an updated and saved application, in a new version of an application developing platform, corresponding MR software for the new version is incapable of interpreting and recognizing any previously added or updated changes in the previous platform version. Serialization also suffers from not being supported in all Java classes, which are required in MR software.

Archiving mechanisms have similar versioning and universal class incompatibility issues, as that of serialization. Also, archiving techniques require traversing a hierarchy of components and comparing default settings of every object with current object settings to determine which object settings have been changed. This can take considerable time.

Save and restore mechanisms that are capable of saving an updated application in a compatible MR imaging system format can lack the capability of performing any additional modifications, such as adding functions to a saved application. In order to perform additional modifications to a previously updated and saved application the previous modifications and any new modifications need all be reentered. The reentering of modifications is undesirable due to the repeated work steps and time involved therein.

Thus, there exists a need for an improved system and method of saving and restoring MR applications that is compatible with existing MR imaging development software and allows for the building, reusing, modifying, saving, and restoring of previously updated applications.

### SUMMARY OF INVENTION

The present invention provides a system and method for saving and restoring applications for an imaging system. The method includes loading a developing environment. An initial application for the imaging system is loaded into or generated within the developing environment. The initial application is modified to generate an updated application. The component and link modifications between the initial application and the updated application are saved. The updated application is then stored with the modifications in a tag file. The tag file is selected and the updated application is restored according to the tag file.

The embodiments of the present invention provide several advantages over existing MR imaging application development tools. One such advantage that is provided by multiple embodiments of the present invention is the provision of a saving and restoring technique that is compatible with multiple existing development platforms and is not development platform version limited. The stated embodiments allow for applications of various platform versions to be initialized, setup, used, modified, saved, and restored.

Another advantage provided by an embodiment of the present invention is the allowance of an application to be modified, saved, and restored an indefinite amount of times without incurring extra overhead, due to the saving of the last modification to a property of a component rather than the accumulating of user edits that are redundant.

Furthermore, another advantage provided by an embodiment of the present invention is the ability to perform easy and quick modifications to applications. An application may be modified within or external from an application developing environment.

Moreover, yet another advantage provided by an embodiment of the present invention is the provision of an application save and restore system that is efficient at the loading and restoring of applications.

The present invention itself, together with further objects and attendant advantages, will be best understood by reference to the following detailed description, taken in conjunction with the accompanying drawing.

### BRIEF DESCRIPTION OF DRAWINGS

FIG. 1 is a cross-sectional and block diagrammatic view of a MR imaging system utilizing an application save and restore system in accordance with an embodiment of the present invention.

FIG. 2 is a block diagrammatic view of the application save and restore system in accordance with an embodiment of the present invention; and.

FIG. 3 is a logic flow diagram illustrating a method of saving and restoring an application for the MR imaging system of FIG. 1 in accordance with an embodiment of the present invention.

### DETAILED DESCRIPTION

In each of the following figures, the same reference numerals are used to refer to the same components. While the present invention is described with respect to a system and method of storing and restoring magnetic resonance developed applications, the present invention may be adapted for various systems including magnetic resonance imaging (MRI) systems, computed tomography (CT) systems, radiotherapy systems, X-ray imaging systems, ultrasound systems, nuclear imaging systems, magnetic resonance spectroscopy systems, or other system known in the art. Also, the present invention may be applied to various applications in various fields of endeavor.

In the following description, various operating parameters and components are described for one constructed embodiment. These specific parameters and components are included as examples and are not meant to be limiting.

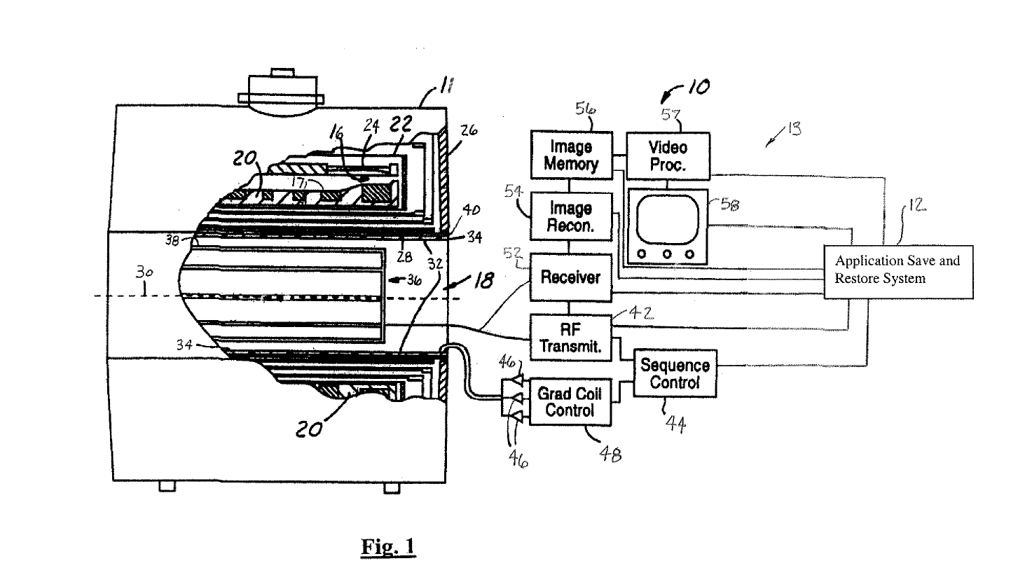

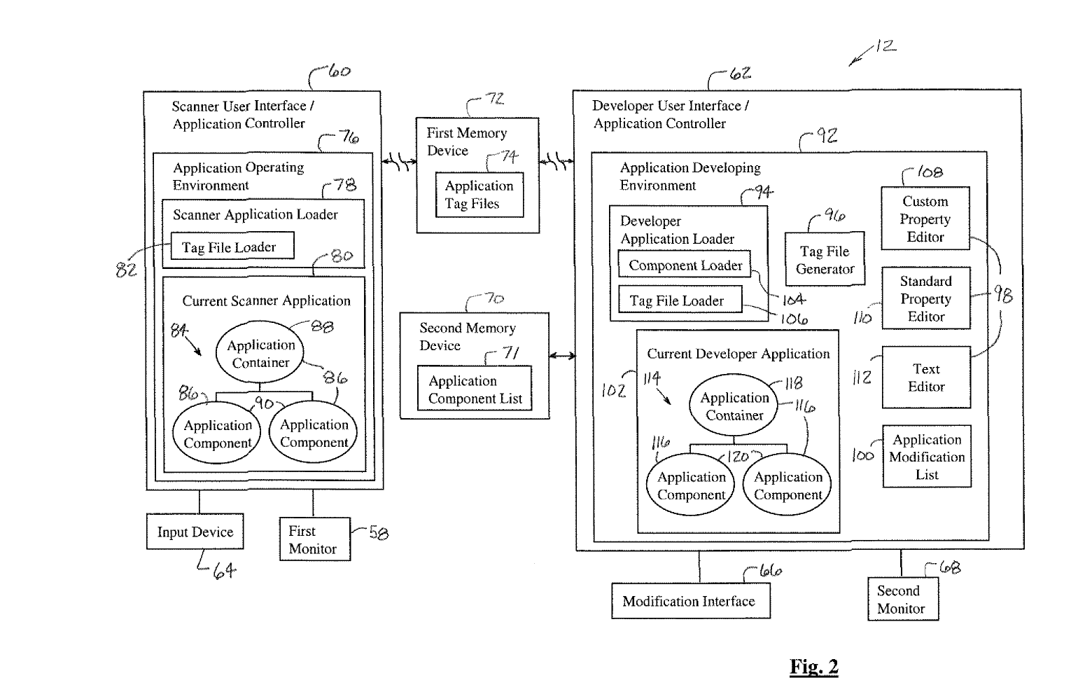

Referring now to FIG. 1, a cross-sectional and block diagrammatic view of a magnetic resonance (MR) imaging system 10 utilizing an application save and restore system 12 in accordance with an embodiment of the present invention is shown. The MRI system 10 includes a static magnet structure 11 (a cylindrical structure) and a signal processing system 13. The signal processing system 13 is coupled to the magnet structure 11 and reconstructs an image for a region-of-interest of a patient in response to radio frequency magnetic resonance signals, as further described below. The application system 12 is coupled to several devices of the imaging system 10 and is used in the creating, developing, saving, and restoring applications. The applications are loaded within the application system 12 and are used in the control of the imaging system 10. The application system 12 is described in detail below with respect to the embodiment of FIG. 2.

The static magnet structure 11 includes a superconducting magnet 16 having multiple superconducting magnetic field coils 17, which generate a temporally constant magnetic field along a longitudinal axis (z-axis) of a central bore 18 (patient bore). The superconducting magnet coils 17 are supported by a superconducting magnet coil support structure 20 and are received in a toroidal helium vessel or can 22.

A main magnetic field shield coil assembly 24 generates a magnetic field that opposes the field generated by the superconducting magnet coils 17. A toroidal vacuum vessel 26 includes a cylindrical member 28 that defines the patient bore 18 and extends parallel to a longitudinal axis 30. On a first exterior side 32 of the cylindrical member 28, which is the longitudinal side farthest away from the axis 30, is a magnetic gradient coil assembly 34.

The patient bore 18 has a RF coil assembly 36 (antennae) mounted therein. The RF coil assembly 36 includes a primary RF coil 38 and a RF shield 40.

The signal processing system 13 includes a RF transmitter 42 that is coupled to a sequence controller 44 and the primary RF coil 38. The RF transmitter 42 is preferably digital. The sequence controller 44 controls a series of current pulse generators 46 via a gradient coil controller 48 that is connected to the magnetic gradient coil assembly 34. The RF transmitter 42 in conjunction with the sequence controller 44 generates a series of spatially located radio frequency signals or encoded magnetic field gradient pulses. The gradient pulses are applied across a region-of-interest within the magnetic field for exciting and manipulating magnetic resonance in selected dipoles of the region-of-interest, such as a portion of a patient within the patient bore 18.

A radio frequency receiver 52 is connected with the primary RF coil 38 for the demodulation of magnetic resonance signals that emanate from an examined portion of the subject. An image reconstruction apparatus 54 reconstructs the received magnetic resonance signals into an electronic image representation that is stored in an image memory 56. A video processor 57 converts the stored electronic images into an appropriate format for the display on a first monitor 58. The reconstructed image may be observed by the operator on the display 58, as well as other data from the restoring system 12.

Referring now to FIG. 2, a block diagrammatic view of the application system 12 in accordance with an embodiment of the present invention is shown. The application system 12 includes a scanner user interface 60 and a developer user interface 62, both of which may be considered application controllers.

The scanner interface 60 is coupled to and controls operation of the signal processing system 13. Applications may be loaded by the scanner interface 60 and executed. The scanner interface 60 receives commands and scanning parameters, via an input device 64, which are used in operation of the system 10.

The developer interface 62 is used for the development of various imaging system applications. Although the scanner interface and the developer interface are shown as separate interfaces, they may be combined into a single interface. The single interface may be coupled to the signal processing system 13 and perform both operation and development tasks. Also, although a single scanner interface and a single developer interface are shown, any number of each may exist within the application system 12.

The scanner interface 60 and the developer interface 62 may be microprocessor based, such as a computer having a central processing unit, memory (RAM and/or ROM), and associated input and output buses. The scanner interface 60 and the developer interface 62 may be a portion of a central or main control unit or may each be stand-alone components as shown.

The scanner interface 60 is coupled to the input device 64 and the first monitor 58. The developer interface 62 is coupled to a modification interface 66 and a second monitor 68. The input device 64 and the modification interface 66 may be in the form of a keyboard or a mouse, by which an operator may operate, generate, modify, save, upload, and restore imaging system applications, as well as perform other tasks known in the art. The input device 64 and the modification interface 66, although are described as being hardware based, may be software based. By being software based other system control methods, known in the art, may use the input device 64 and the modification interface 66 to generate various signals corresponding to the above stated tasks.

The scanner interface 60 and the developer interface 62 may be located at a single location or may be at separate locations. For example, the scanner interface 60 may be located at a customer site and the developer interface 62 may be located at a manufacturer site.

The scanner interface 60 and the developer interface 62 have access to a first memory 72, which has stored application tag files 74. The tag files 74 may be structured files. The tag files are in an extensible markup language (XML) text file format or the like having the latest modifications for a current session. The tag files 74 may be digitally signed or password protected to prevent unauthorized modification of the tag files 74. The tag files allows a user to directly read a particular tag file and perform edits. The tag files also allow for restoring and editing of files without being dependent on application classes, such as prior art methods that utilize serialization.

The first memory 72 may be located at a central location, at the site of the scanner interface 60, at the site of the developer interface 62, or may be divided into separate memories having similar contents. The interfaces 60 and 62 may access the first memory 72 via a wired connection, a wireless connection, a network, an Internet, an Intranet, or via some other connection known in the art.

The first memory 72 stores the latest application modifications and linking information for the various application components. The application components may be continuously stored and may be of various types and styles, as known in the art. The application components may apply to pulse sequencing and data processing, to visualization and image reconstruction, or to other imaging system categories known in the art. The linking information includes information, such as the manner as to which components are coupled or interlinked. The linking information also includes parameter or property types that are transferred between components, such as various input and output values or signals that may be performed in a particular order, used from one component to the next, or between multiple components. For example, a Fast Fourier Transform (FFT) component may be coupled to a phase component and output from the FFT component may be used as an input to the phase component.

The developer interface 62 also has access to a second memory 70, which stores a framework or application component list 71. The application component list 71 includes the available components that may be used to create and develop a desired application. As new components become available they are added to the application component list 71. The scanner interface 60 may have access to the second memory 70, such as when the scanner interface 60 and the developer interface 62 are incorporated into a single interface.

The scanner interface 60 may be software based and have various operating windows (not shown), some of which may contain various components and software modules for performing desired system operating tasks. The scanner interface 60 includes an application operating environment 76 that includes a scanner application loader 78 and a current scanner application 80. The scanner application loader 78 is used to load and restore a desired application. When the desired application is in the form of a tag file 74, the scanner loader 78 uses a tag file loader 82 to retrieve the appropriate tag file from the first memory 72.

The scanner application 80 includes an application component organizational chart or application component tree 84 that has multiple application components 86 that were originally selected from the application component list 71. The application tree 84 has a hierarchal design that corresponds to the manner as to which the components 86 are linked. The hierarchial design refers to the order that the components 86 and corresponding tasks are performed and the interdependent relationships between the components 86. The application tree 84 has a first application component or application container 88 and subordinate application components 90 extending therefrom. The application tree 84 may be of various sizes and have any number of application components. Each application component 86 may have any number of application components extending therefrom. Although the application components 86 are shown as being organized in the form of an application component tree, the application components 86 may be organized using some other organizational technique known in the art.

The developer interface 62 includes an application developing environment 92, which may also be software based and have various operating windows (not shown), some of which contain various components, and software modules for performing desired development tasks. The application developing environment 92 may be used to modify the application component list 71 and the components within the list 71. The developer interface 62 may receive modification signals from the modification interface 66 and in response thereto modify the application component list 71, the components within the list 71, and any corresponding linking information between the components. The developer interface 62 may add components to or remove components from the application list 74, change arrangement of the components, change linking information between the components, or perform some other component modification known in the art.

The developing environment 92 includes a developer application loader 94, a tag file generator 96, multiple editors 98, an application modification list 100, and a current developer application 102. The development loader 94 includes a component loader 104 and a tag file loader 106, which is similar to the tag file loader 82. The component loader 104 is utilized to load a component in the component list 74 into the developing environment 92. The tag file loader 106 may be utilized to restore a previous application. The tag file loader 106 restores a previous application according to an associated tag file 74. The developer loader 94 may open and modify a corresponding default application, generate an application according to the tag file, or generate an application utilizing components from the application component list 71. The developer loader 94 also resets any properties or values generated by the custom property editor 108 or from the standard property editor 110, as stored in the tag file 74.

The tag file generator 96 generates and stores the tag files of the updated applications, with the component modifications and corresponding component linking information, in the first memory 72. The application system 12 stores the component related information in a tag file and in so doing provides flexibility in performing development application modifications.

The editors 98 include the custom property editor 108, the standard editor 110, and the text editor 112. The custom property editor 108 is used to perform custom edits to an application component. The custom property editor 108 generates custom values such as a value of a parameter not normally used. The custom property editor 108 is used for properties, which are not standard Java types (int, char, etc.) or custom data types. The custom data types may include data or values that are not custom in nature. The developer interface 62 stores the custom values as they are generated in the application modification list 100. The standard editor 110 is used to perform various normal or standard modifications to an application component using standard data types.

The text editor 112 is used to directly perform edits to an application component's property tags. A tag file may be modified within or external from the developing environment 92. In other words, an application component of interest may be modified using the developing environment 92 or may be modified by simply opening and modifying the tag file without initializing or executing the developing environment 92. When a small quantity of modifications are to be performed, external modification to the tag file may be desired, since it provides increased efficiency and ease in modifying and developing an application. Also, the tag file allows an operator to view the modifications that have been performed by simply reviewing contents of the tag file. The application component may be viewed in a text format and code or values therein may be quickly and directly changed. In one embodiment of the present invention, the text editor 112 is used to perform a quick value change. The text editor 112 is used to view and change the value within a specific application component. The application component is viewed in the text editor 112 without uploading or restoring an entire application.

The application modification list 100 is a list of the latest application modifications that have been performed for the application components in the developer application 102. As application components or linking information are modified the modification list 100 is modified as to the changes, which is explained in further detail below. The modification list 100 may be stored in the first memory 72, the second memory 70, or in some other computer or designated memory.

The developer application 102 as with the scanner application includes a component tree 114 that has multiple application components 116. The component tree 114 has a first application component or application container 118 and subordinate application components 120 extending therefrom. The component tree 114 may be of various sizes and have any number of application components. Each application component 120 may have any number of application components extending therefrom. Although the application components 120 are shown as being organized in the form of an application component tree, the application components 120 may be organized using some other organizational technique known in the art.

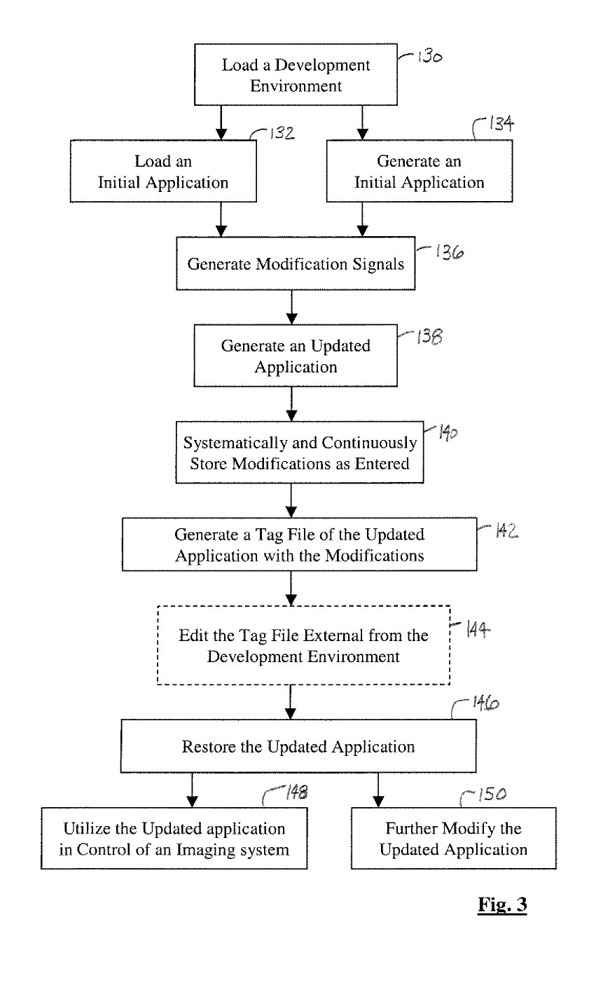

Referring now to FIG. 3, a logic flow diagram illustrating a method of saving and restoring an application for the MR imaging system 10 in accordance with an embodiment of the present invention is shown.

In step 130, the developer interface 62 loads the developing environment 92.

In step 132, the developer loader 94 loads an initial application in the developing environment 92. The developer loader 94 loads and initializes a development application as selected by an operator. The initial application has one or more components that are in an initial component state with initial values and settings, which may be different than that of corresponding default values and settings. For example, the initial application may have one or more components that have been modified or stored previously with values and settings that are different from their default values and settings.

In step 134, an initial application is generated in response to input signals that are generated from the modification interface 66. The operator may generate a new application using components from the application list 74.

In step 136, the operator, via the modification interface 66, or the developer interface 62 generates modification signals to alter the initial development application. Components within the application list 74 may be added, removed, modified, or repositioned using various techniques known in the art.

In step 138, the developer interface 62 in response to the modification signals modifies the initial application to generate an updated application.

In step 140, as modification signals are generated and components and link information are modified, the developer interface 62 stores the modifications in the modification list 100. The systematic storing of the modifications as they are entered or enacted saves time in storing of an updated application. A modification is saved when it is different than a current value or setting. Previous modifications of the same property are discarded as changes are made to that property.

Certain values may not be saved and later restored. These values may be used solely during the development of an application, such as a value prescribed on the developer interface 62 of the application. Prescribing a development application may be done during the building of an application for test purposes, but since the prescription is not actually part of the application it is not saved.

In step 142, when desired modifications have been performed the tag file generator 96 saves the updated application with the modifications in a generated tag file. The updated application is stored quickly since the modifications are stored as they are performed and no comparisons between the initial application and the updated application need be performed.

The tag file generator 96 in storing the updated application stores general multiversion identifiers associated with each component. Through the use of multiversion identifiers, the present invention is not version limited, as application saving and restoring methods of prior art. The multiversion identifiers identify general components by name without use of version identification numbers. The developer interface 62 when initializing an application as in steps 132 and 134 searches for a component in memory having the multiversion identifier and initializes that component.

In step 144, the tag file may be edited to modify the updated application external from the developing environment 92. The tag file may be edited using the text editor 112, as described above.

In step 146, the scanner interface 60 or the developer interface 62 restores the updated application according to the tag file. After the updated application has been stored it may be accessed and restored by either the interface 60 or the interface 62. The tag file is read and the stored updated application is constructed in the operating environment 76 or in the developing environment 92 with property settings and node connections of the application components, as stated in the tag file. The updated application with the modifications when restored is in the same state as when it was originally created or modified, as in steps 130-142.

In step 148, upon restoration of the updated application an operator may utilize the updated application, in the operating environment 76, to control the operation of the imaging system 10.

In step 150, the updated application may be further modified, within the developing environment. This is unlike development application store and restore techniques of prior art in which stored files are unable to be modified to add new functionality.

The present invention performs the above save and restore techniques using the developer interface 62 without separately generating or writing source code.

The above-described steps in the above methods are meant to be an illustrative example; the steps may be performed sequentially, synchronously, continuously, or in a different order depending upon the application.

The present invention saves and restores applications in such a manner as to allow for the modification of restored applications without being version limited. The present invention decreases development time, since previously modified applications may be restored and further modified. The present invention also provides increased versatility and efficiency in performing the modifications through use of a tag file.

The above-described apparatus and method, to one skilled in the art, is capable of being adapted for various applications and systems known in the art. The above-described invention can also be varied without deviating from the true scope of the invention.

1. A method of saving and restoring an application for an imaging system comprising:
loading a developing environment;
loading or generating an initial application for the imaging system in said developing environment;
modifying said initial application to generate an updated application;
saving component and link modifications between said initial application and said updated application; then storing said updated application with said modifications in a tag file;
selecting said tag file; and
restoring said updated application according to said tag file.

2. A method as in claim 1 wherein said component and link modifications are saved in response to enactment of said modifications.

3. A method as in claim 1 wherein said component and link modifications are saved in response to an inputted request.

4. A method as in claim 1 wherein said initial application is loaded and generated in said developing environment.

5. A method as in claim 1 wherein saving said changes comprises saving latest changes that are different from initial default values.

6. A method as in claim 1 wherein saving said updated application with said changes comprises saving latest changes in a text file.

7. A method as in claim 6 wherein said text file is modified external to said developing environment.

8. A method as in claim 1 further comprising modifying said tag file to create a newly updated application.

9. A method as in claim 1 wherein said changes between said initial application and said updated application are saved upon modification thereof.

10. A method as in claim 1 wherein saving changes between said initial application and said updated application are performed for components having a latest component state that is different than an initial component state.

11. A method as in claim 1 wherein saving changes between said initial application and said updated application are performed for latest component values.

12. A method as in claim 1 wherein saving changes between said initial application and said updated application are performed for components having updated values that are different from corresponding default values.

13. An application save and restore system for an imaging system comprising:
an application component list having a plurality of available components configured for the imaging system;
an application component organizational chart corresponding to a current application and having one or more application components from said plurality of available components;
a plurality of modification inputs receiving a plurality of modification signals;
a developer interface modifying said application components and corresponding linking information in response to said modification signals;
said developer interface storing latest development modifications for said application components in an application modification list in response to modification of said application components;
a tag file generator generating and storing a tag file of an updated application with said component modifications and corresponding component linking information; and
an application loader restoring said updated application according to said tag file.

14. A tool as in claim 13 wherein said developer interface in modifying said application components performs a modification selected from at least one of changing an existing application component, adding an application component to said application component organizational chart, removing an application component from said application component organizational chart, modifying linking information between said application components, and changing position of an application component.

15. A tool as in claim 13 wherein said tag file generator in storing a tag file stores a text file.

16. A tool as in claim 13 wherein said developer interface is continuously storing said latest development application modifications upon enactment of said modifications.

17. A tool as in claim 13 wherein said developer interface modifies said updated development application after said application loader restores said updated application.

18. A tool as in claim 13 further comprising a custom property editor generating a custom value and said developer interface storing said custom value.

19. A tool as in claim 18 wherein said application loader when restoring said updated application resets a property corresponding to said custom value.

20. A system as in claim 13 wherein said tag file generator in storing a tag file of an updated application stores general multiversion identifiers associated with said application components.

21. An application save and restore system for an imaging system comprising:
a modification interface generating modification signals to update a current application of the imaging system;
a memory device storing latest application modifications and linking information for a plurality of current application components;
a first controller coupled to said modification interface and said memory device and receiving said modification signals, continuously storing said latest application modifications, and generating and storing a tag file having said application with said modifications and linking information; and
a second controller restoring said updated application according to said tag file.

22. A system as in claim 21 wherein said first controller modifies said current development application by adding and removing components to and from said current application in response to said modification signals.

23. A system as in claim 21 wherein said controller modifies a current application in a text file external to a developing environment.

24. A system as in claim 21 wherein said second controller is coupled to and controls operation of the imaging system.

25. A system as in claim 21 wherein said first controller accesses said tag file via a network.

26. A system as in claim 21 wherein said second controller accesses said tag file via a network.

27. A system as in claim 21 wherein said first controller and said second controller are integrally formed as a single controller.

28. A system as in claim 21 wherein an application component list is accessible to said first controller and is inaccessible to said second controller.
